(19) United States
(12) Patent Application Publication
(10) Pub. No.: US 2024/0300515 A1
(43) Pub. Date: Sep. 12, 2024

(54) SYSTEMS AND METHODS FOR DETECTING AND LABELING A COLLIDABILITY OF ONE OR MORE OBSTACLES ALONG TRAJECTORIES OF AUTONOMOUS VEHICLES

(71) Applicant: Kodiak Robotics, Inc., Mountain View, CA (US)

(72) Inventors: Yinsen Jia, New York, NY (US); Colin Otis, Driggs, ID (US); Abhyuday Puri, New York, NY (US)

(21) Appl. No.: 18/178,720

(22) Filed: Mar. 6, 2023

(51) Int. Cl. B60W 60/00; B60W 30/09; B60W 40/02; G01S 17/86; G01S 17/931; G06V 20/58; G06V 20/70

(52) U.S. Cl. CPC B60W 60/001; B60W 30/09; B60W 40/02; G01S 17/86; G01S 17/931; G06V 20/58; G06V 20/70; B60W 2420/403; B60W 2420/408; B60W 2554/00; G06V 10/267; G06V 20/188; G06V 2201/08

(57) ABSTRACT

Systems and methods for detecting and labeling a collidability of obstacles within a vehicle environment are provided. The method may comprise generating one or more data points from one or more sensors coupled to a vehicle. The method may comprise, using a processor, detecting one or more obstacles within a LiDAR point cloud, generating a patch for each of the one or more detected obstacles, projecting the LiDAR point cloud into the image, performing a factor query on an image for each of the one or more detected obstacles, for each of the one or more detected obstacles, based on the factor query, determining a label for the obstacle, and, for each of the one or more detected obstacles, labeling the obstacle with the label. The label may indicate whether each of the one or more detected obstacles is collidable and not non-collidable.

### BACKGROUND

### Field of the Disclosure

Embodiments of the present disclosure relate to obstacle detection and, in particular, to detecting and identifying one or more obstacles within a vehicle environment, determining the collidability of the one or obstacles, and adjusting driving instructions for vehicle accordingly.

### Description of the Related Art

To safely and efficiently navigate an environment and prevent possible collision, self-driving or otherwise autonomous vehicles (AVs) require the ability to detect one or more objects, obstacles, and/or road surface conditions within an environment of the AV. To detect these objects and potential hazards, AVs are often equipped with one or more types of environmental sensing technologies, such as, e.g., photographic imaging systems and technologies (e.g., cameras), radio detection and ranging (RADAR) systems and technologies, and Light Detection and Ranging (LiDAR) systems and technologies, among other suitable environmental sensing technologies.

A LIDAR sensor is configured to emit light, which strikes material (e.g., objects) within the vicinity of the LiDAR sensor. Once the light contacts the material, the light is deflected. Some of the deflected light bounces back to the LiDAR sensor. The LiDAR sensor is configured to measure data pertaining to the light bounced back (e.g., the distance traveled by the light, the length of time it took for the light to travel from and to the LiDAR sensors, the intensity of the light returning to the LiDAR sensor, etc.). This data can then be used to generate a point cloud reflecting some or all of the environment around the LiDAR sensor, generally recreating an object map of the objects within the environment.

When used on a vehicle, the LiDAR sensor can be used to detect one or more objects within the environment of the vehicle. General use of LiDAR in AVs is beneficial in detecting the presence and/or absence of objects and/or obstacles within the environment of the AVs, to ensure that the AVs do not collide with the objects and/or obstacles. However, LiDAR generally has difficulty distinguishing between different types of objects and/or obstacles within the environment of the AV. For example, LiDAR detection often classifies vegetation as vehicles due to the similarities in the point-cloud shapes between vehicles and vegetation. Because of this, LiDAR detection may cause an AV to stop for vegetation, even as small as a blade of grass.

Misclassification of vegetation along an environment of an AV increases the problems of over-braking which degrades ride quality and introduces complexities in motion planning. Additionally, this may cause A Vs to run slower and more inefficiently and may increase the chances of the AV being rear-ended when it is moving in a complex environment.

In many instances, it may be beneficial for an AV to collide with vegetation. For example, colliding with vegetation may be beneficial in order to make progress on the road without undue danger and/or damage to the AV (e.g., an overhanging bush may be brushed aside by the AV without issue), in order to prevent unsafe driving due to unnatural behavior (e.g., hard braking for a tree branch may cause rear end collisions if the driver controlling the vehicle is not paying attention), and/or to make an informed decision to fully avoid one object over another (e.g., it may be beneficial to fully avoid a collision with a vehicle passing too close to the left by driving over a big clump of grass). However, objects (e.g., pedestrians or objects which may pose a danger to the AV) may be hidden by vegetation. In these instances, it would be detrimental to collide with the vegetation.

Therefore, for at least these reasons, systems and methods for detecting and identifying vegetation within an environment of an AV in order to determine whether the AV may collide with vegetation are needed.

### SUMMARY

According to an object of the present disclosure, a method for detecting and labeling a collidability of obstacles within a vehicle environment is provided. The method may comprise generating one or more data points from one or more sensors coupled to a vehicle. The one or more sensors may comprise a Light Detection and Ranging (LiDAR) sensor and a camera, and the one or more data points may comprise a LiDAR point cloud generated by the LiDAR sensor and an image captured by the camera. The method may comprise, using a processor, detecting one or more obstacles within the LiDAR point cloud, performing a factor query on the image for each of the one or more detected obstacles, for each of the one or more detected obstacles, based on the factor query, determining a label for the obstacle, and, for each of the one or more detected obstacles, labeling the obstacle with the label. The label may indicate whether each of the one or more detected obstacles is collidable and not non-collidable.

According to various embodiments, the performing the factor query may comprise one or more of: performing a color query on the image for each of the one or more detected obstacles; performing a shape query on the image for each of the one or more detected obstacles; and performing a movement query on the image for each of the one or more detected obstacles.

According to various embodiments, the method may further comprise, using the processor, for each of the one or more detected obstacles, based on the label of the obstacle, determining one or more vehicle actions for the vehicle to perform, and causing the vehicle to perform the one or more actions.

According to various embodiments, the one or more actions may comprise one or more of: increasing a speed of the vehicle; decreasing a speed of the vehicle; stopping the vehicle; and adjusting a trajectory of the vehicle.

According to various embodiments, the method may further comprise generating a patch for each of the one or more detected obstacles and projecting the LiDAR point cloud into the image. Each patch represents a region of the image for each of the one or more detected obstacles, each patch may forms a bounding box on the image, and the method may further comprise cropping the region of the image within the bounding box, forming a cropped image.

According to various embodiments, the method may further comprise resizing the cropped image, forming a resized image. The performing the factor query may comprise performing the factor query on the resized image.

According to various embodiments, the method may further comprise, for each of the one or more detected obstacles, based on the factor query, determining whether the obstacle is one or more of: a piece of vegetation; a pedestrian; and a vehicle.

According to an object of the present disclosure, a system for detecting and labeling a collidability of obstacles within a vehicle environment is provided. The system may comprise a vehicle and one or more sensors, coupled to the vehicle, configured to generate one or more data points. The one or more sensors may comprise a LiDAR sensor and a camera, and the one or more data points may comprise a LiDAR point cloud generated by the LiDAR sensor and an image captured by the camera. The system may comprise a processor configured to detect one or more obstacles within the LiDAR point cloud, perform a factor query on the image for each of the one or more detected obstacles, for each of the one or more detected obstacles, based on the factor query, determine a label for the obstacle, and, for each of the one or more detected obstacles, label the obstacle with the label. The label may indicate whether each of the one or more detected obstacles is collidable and not non-collidable.

According to various embodiments, the performing the factor query may comprise one or more of: performing a color query on the image for each of the one or more detected obstacles; performing a shape query on the image for each of the one or more detected obstacles; and performing a movement query on the image for each of the one or more detected obstacles.

According to various embodiments, the processor may be further configured to, for each of the one or more detected obstacles, based on the label of the obstacle, determine one or more vehicle actions for the vehicle to perform, and cause the vehicle to perform the one or more actions.

According to various embodiments, the one or more actions may comprise one or more of: increasing a speed of the vehicle; decreasing a speed of the vehicle; stopping the vehicle; and adjusting a trajectory of the vehicle.

According to various embodiments, the processor may be further configured to generate a patch for each of the one or more detected obstacles and project the LiDAR point cloud into the image. Each patch may represent a region of the image for each of the one or more detected obstacles, each patch may form a bounding box on the image, and the processor may be further configured to crop the region of the image within the bounding box, forming a cropped image.

According to various embodiments, the processor may be further configured to resize the cropped image, forming a resized image, and the performing the factor query may comprise performing the factor query on the resized image.

According to various embodiments, the processor may be further configured to, for each of the one or more detected obstacles, based on the factor query, determine whether the obstacle is one or more of: a piece of vegetation; a pedestrian; and a vehicle.

According to an object of the present disclosure, a system for detecting and labeling a collidability of obstacles within a vehicle environment is provided. The system may comprise a vehicle and one or more sensors, coupled to the vehicle, configured to generate one or more data points. The one or more sensors may comprise a LiDAR sensor and a camera, and the one or more data points may comprise a LiDAR point cloud generated by the LiDAR sensor and an image captured by the camera. The system may comprise a computing device, comprising a processor and a memory, coupled to the vehicle, configured to store programming instructions. The programming instructions, when executed by the processor, may cause the processor to detect one or more obstacles within the LiDAR point cloud, perform a factor query on the image for each of the one or more detected obstacles, for each of the one or more detected obstacles, based on the factor query, determine a label for the obstacle, and, for each of the one or more detected obstacles, label the obstacle with the label. The label may indicate whether each of the one or more detected obstacles is collidable and not non-collidable.

According to various embodiments, the performing the factor query may comprise one or more of: performing a color query on the image for each of the one or more detected obstacles; performing a shape query on the image for each of the one or more detected obstacles; and performing a movement query on the image for each of the one or more detected obstacles.

According to various embodiments, the programming instructions may be further configured, when executed by the processor, to cause the processor to, for each of the one or more detected obstacles, based on the label of the obstacle, determine one or more vehicle actions for the vehicle to perform, and cause the vehicle to perform the one or more actions.

According to various embodiments, the one or more actions may comprise one or more of: increasing a speed of the vehicle; decreasing a speed of the vehicle; stopping the vehicle; and adjusting a trajectory of the vehicle.

According to various embodiments, the programming instructions may be further configured, when executed by the processor, to cause the processor to generate a patch for each of the one or more detected obstacles and project the LiDAR point cloud into the image. Each patch represents a region of the image for each of the one or more detected obstacles, each patch may form a bounding box on the image, and the programming instructions may be further configured, when executed by the processor, to cause the processor to crop the region of the image within the bounding box, forming a cropped image, and resize the cropped image, forming a resized image. The performing the factor query may comprise performing the factor query on the resized image.

According to various embodiments, the programming instructions may be further configured, when executed by the processor, to cause the processor to, for each of the one or more detected obstacles, based on the factor query, determine whether the obstacle is one or more of: a piece of vegetation; a pedestrian; and a vehicle.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 shows an example Light Detection and Ranging (LiDAR)-equipped and camera-equipped vehicle on a roadway, according to various embodiments of the present disclosure;

FIG. 2 is an example block diagram of a perception system of a vehicle, according to various embodiments of the present disclosure;

FIGS. 3A-3B are an example flowchart of a method for detecting and identifying vegetation within a vehicle environment and adjusting driving instructions for vehicle accordingly, according to various embodiments of the present disclosure;

FIG. 4 is an example flowchart of a method for labeling one or more obstacles, according to various embodiments of the present disclosure;

FIG. 5 illustrates example elements of a computing device, according to various embodiments of the present disclosure; and

FIG. 6 shows example architecture of a vehicle, according to various embodiments of the present disclosure.

### DETAILED DESCRIPTION

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

In this document, when terms such as “first” and “second” are used to modify a noun, such use is simply intended to distinguish one item from another, and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

An “electronic device” or a “computing device” refers to a device that includes a processor and memory. Each device may have its own processor and/or memory, or the processor and/or memory may be shared with other devices as in a virtual machine or container arrangement. The memory may contain or receive programming instructions that, when executed by the processor, cause the electronic device to perform one or more operations according to the programming instructions.

The terms “memory,” “memory device,” “computer-readable storage medium,” “data store,” “data storage facility” and the like each refer to a non-transitory device on which computer-readable data, programming instructions or both are stored. Except where specifically stated otherwise, the terms “memory,” “memory device,” “computer-readable storage medium,” “data store,” “data storage facility” and the like are intended to include single device embodiments, embodiments in which multiple memory devices together or collectively store a set of data or instructions, as well as individual sectors within such devices.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

The term “module” refers to a set of computer-readable programming instructions, as executed by a processor, that cause the processor to perform a specified function.

The term “vehicle,” or other similar terms, refers to any motor vehicles, powered by any suitable power source, capable of transporting one or more passengers and/or cargo. The term “vehicle” includes, but is not limited to, autonomous vehicles (i.e., vehicles not requiring a human operator and/or requiring limited operation by a human operator, either onboard or remotely), automobiles (e.g., cars, trucks, sports utility vehicles, vans, buses, commercial vehicles, class 8 trucks etc.), boats, drones, trains, and the like.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable programming instructions executed by a processor, controller, or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network-coupled computer systems so that the computer readable media may be stored and executed in a distributed fashion such as, e.g., by a telematics server or a Controller Area Network (CAN).

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value.

Hereinafter, some embodiments of the present disclosure will be described in detail with reference to the drawings. In the drawings, the same reference numerals will be used throughout to designate the same or equivalent elements. In addition, a detailed description of well-known features or functions will be ruled out in order not to unnecessarily obscure the gist of the present disclosure.

Hereinafter, systems and methods for detecting and identifying vegetation along a vehicle (e.g., an autonomous vehicle (AV)) trajectory and adjusting driving instructions for the vehicle accordingly, according to embodiments of the present disclosure, will be described with reference to the accompanying drawings.

According to various embodiments of the present disclosure, in order to improve sensor performance and in order to improve vehicle understanding of different obstacles, systems and methods are provided which may fuse camera information with Light Detection and Ranging (LiDAR) information in order to better classify vegetation within an environment of a vehicle.

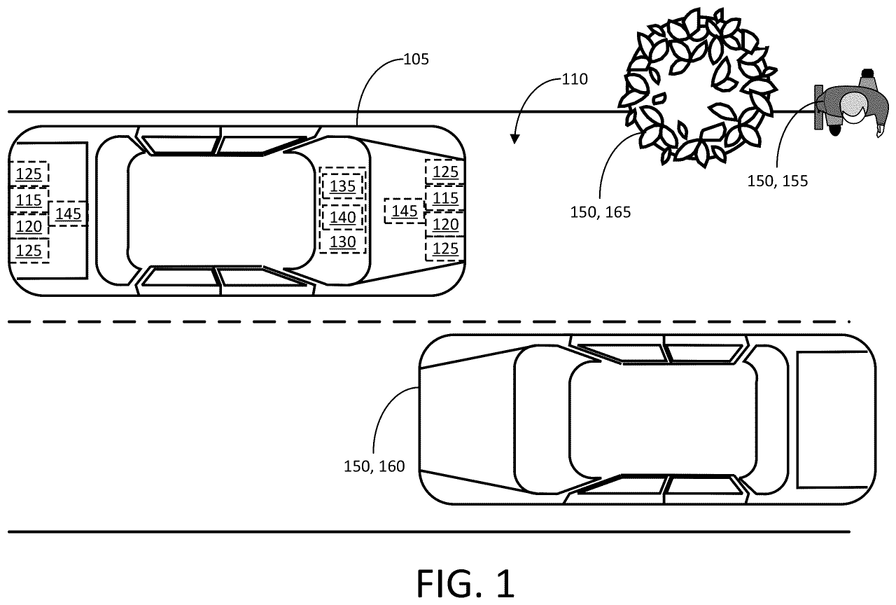

Referring now to FIG. 1, an example LiDAR-equipped and camera-equipped vehicle 105 on a roadway 110 is provided, in accordance with various embodiments of the present disclosure.

According to various embodiments, the vehicle 105 may comprise one or more sensors such as, for example, one or more LiDAR sensors 115, one or more radio detection and ranging (RADAR) sensors 120, one or more cameras 125, and one or more ultrasonic transducers 145, among other suitable sensors. According to various embodiments, the one or more sensors may be in electronic communication with one or more computing devices 130. The computing devices 130 may be separate from the one or more sensors and/or may be incorporated into the one or more sensors. The vehicle 105 may comprise a LiDAR system which may comprise one or more LiDAR sensors 115 and/or one or more computing devices 130. The vehicle 105 may comprise a camera system which may comprise one or more cameras 125 and/or one or more computing devices 130.

In the example of FIG. 1, the LiDAR sensor 115 may be configured to emit light, which strikes material (e.g., the roadway 110, one or more obstacles 150, rain, snow, etc.) within the environment of the vehicle 105.

According to various embodiments, the one or more obstacles 150 may comprise one or more objects, one or more geographic hindrances to travel, and/or one or more other suitable obstacles 150. According to various embodiments, the one or more obstacles 150 may comprise one or more pedestrians 155, one or more vehicles 160, one or more pieces of vegetation 165, and/or one or more other suitable obstacles 150.

Once the light emitted from the LiDAR sensor 115 comes into contact with the material, the light is deflected. Some of the deflected light bounces back to the LiDAR sensor 115. The LiDAR sensor 115 may be configured to measure data pertaining to the light bounced back (for example, the distance traveled by the light, the length of time it took for the light to travel from and to the LiDAR sensor 115, the intensity of the light returning to the LiDAR sensor 115, and so on as understood by a person of ordinary skill). This data may then be used to generate a point cloud (i.e., data points, in a coordinate system, which represent locations of obstacles within an environment) of some or all of the environment around the vehicle 105, generally recreating an object map of the road surface of the roadway 110, obstacles 150 within the environment, and so on.

According to various embodiments, the LiDAR sensor 115 may be coupled to the vehicle 105 and may be configured to generate one or more point clouds of an environment surrounding the vehicle 105. The environment may fully surround the vehicle or may encompass a portion of the vehicle's 105 surroundings. According to various embodiments, the LiDAR sensor 115 may be in electronic communication and/or coupled to the one or more cameras 125.

According to various embodiments, the computing device 130 may comprise a processor 135 and/or a memory 140. The memory 140 may be configured to store programming instructions that, when executed by the processor 135, are configured to cause the processor 135 to perform one or more tasks such as, e.g., receiving one or more data points from one or more sensors, receiving one or more LiDAR point clouds, detecting one or more obstacles within the one or more LiDAR point clouds, generating one or more patches for each obstacle, projecting one or more patches onto one or more camera images, performing one or more color queries on the one or more camera images, labeling one or more obstacle points, labelling one or more obstacles, determine and/or classifying whether each of the one or more obstacles can and/or cannot be hit by a vehicle, determining one or more vehicle actions, and/or performing one or more vehicle actions, among other functions.

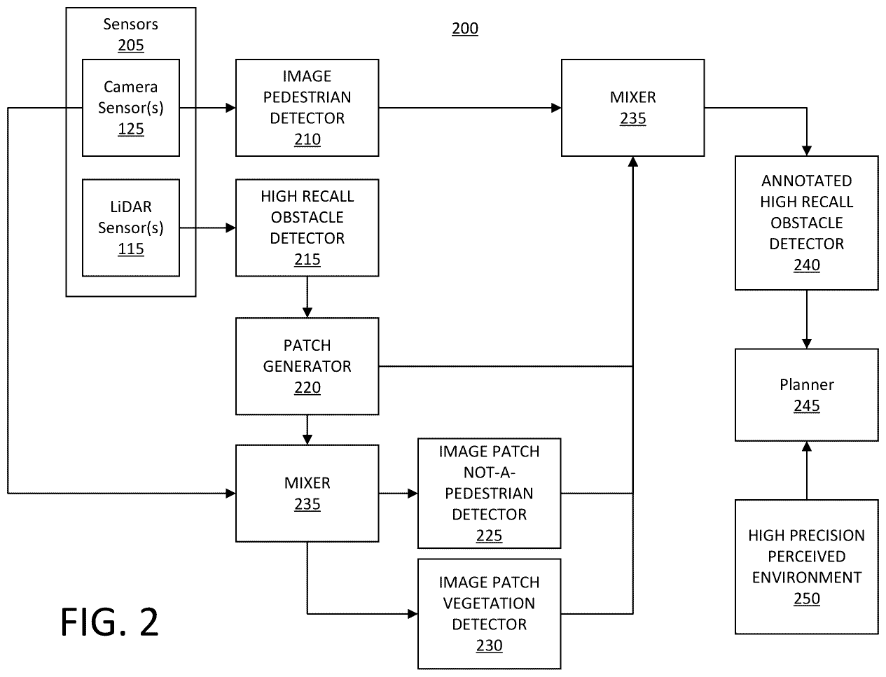

The vehicle 105 may include a perception system 200, such as shown, for example, in FIG. 2. The perception system 200 may be configured to aid the vehicle 105 in identifying/perceiving one or more one or more objects 150 (e.g., pedestrians 155, one or more vehicles 160, one or more pieces of vegetation 165, and/or one or more other suitable obstacles) within the environment of the vehicle 105. The perception system 200 may comprise one or more computing devices 130 and/or may be a component of one or more computing devices 130.

According to various embodiments, the perception system 200 may be configured to detect an obstacle 150, determine whether the obstacle 150 is something that the vehicle 105 can hit, classify the obstacle 150 as something that the vehicle 105 can hit when the it is determined that the obstacle 150 is something that the vehicle 105 can hit. According to various embodiments, the perception system 200 may be configured to determine whether the obstacle 150 is not something that the vehicle 105 cannot hit, and classify the obstacle 150 as not something that the vehicle 105 cannot hit when the it is determined that the obstacle 150 is not something that the vehicle 105 cannot hit. With this information, very high recall can be achieved by the perception system 200 on things that the vehicle 105 cannot hit. According to various embodiments, very high precision may also be achieved when determining whether obstacles 150 are things that the vehicle 105 can or cannot hit, but may need to be able to hit. According to various embodiments, vehicles 160 and pedestrians 155 may be obstacles that the vehicle 105 cannot hit, and pieces of vegetation 165 (or certain types of pieces of vegetation) may be obstacles that the vehicle can hit and not obstacles that the vehicle 105 cannot hit.

According to various embodiments, the perception system 200 may comprise one or more sensors 205 including, for example, LiDAR sensors 115, RADAR sensors, camera sensors 125, etc. The one or more sensors 205 may be coupled to the vehicle 105 and/or may be positioned at any suitable position or positions along a vehicle 105 (e.g., the front, sides, back, top, bottom, etc.).

According to various embodiments, the camera sensor(s) 125 may be in electronic communication with one or more image pedestrian detectors 210 configured to detect whether there are any pedestrians 155 present within one or more images generated by the camera sensor(s) 125. The one or more image pedestrian detectors 120 may be a full image pedestrian detector configured to detect whether there are any pedestrians 155 present within a full image generated by the camera sensor(s) 125.

According to various embodiments, the LiDAR sensor(s) 115 may be in electronic communication with one or more high recall obstacle detectors 215 configured to detect one or more obstacles 150 from a LiDAR point cloud generated by the LiDAR sensor(s) 115. According to various embodiments, the one or more high recall obstacle detectors 215 may be in electric communication with one or more patch generators 220 configured to generate one or more patches along the point cloud indicative of one or more obstacles 150 detected by the one or more high recall obstacle detectors 215.

The one or more image patches may be combined (via, e.g., one or more mixers 235) with one or more images generated by the camera sensor(s) 125. The combined data may be sent to one or more image patch not-a-pedestrian detectors 225 and/or one or more image patch vegetation detectors 230. According to various embodiments, the LiDAR point cloud and/or a portion of the LiDAR point cloud may be projected onto the one or more images generated by the camera sensor(s) 125.

The one or more image patch not-a-pedestrian detectors 225 may be configured to analyze the one or more images along areas indicated by the one or more patches to detect one or more pedestrians 155 within the one or more images within the areas designated by the one or more patches and/or to determine whether there are no pedestrians 155 within the one or more images within the areas designated by the one or more patches. According to various embodiments, obstacles 150 labeled as pedestrians 155 are obstacles 150 which the vehicle 105 cannot hit.

The one or more image patch vegetation detectors 230 may be configured to analyze the one or more images along areas indicated by the one or more patches to detect one or more pieces of vegetation 165 within the one or more images within the areas designated by the one or more patches and/or to determine whether there are no pieces of vegetation 165 within the one or more images within the areas designated by the one or more patches.

A combination of shape and color may be used in the classification of one or more obstacles 150. According to various embodiments, one or more of the image detectors 210, 225, 230 may be configured to query one or more color features for each point of a patched and/or full image. Although the shape of vehicles and vegetation might be similar, color features may be very strong representations which may be used to distinguish them.

The information/data from one or more of the one or more image pedestrian detectors 210, the one or more high recall obstacle detectors 215, the one or more patch generators 220, the one or more image patch not-a-pedestrian detectors 225, and/or the one or more image patch vegetation detectors 230 may be combined (via, e.g., one or more mixers 235) to determine a classification/annotation of one or more obstacles 150. The obstacles 150 may be classified/annotated by one or more annotated high recall obstacle detectors 240. According to various embodiments, the classification/annotation of the one or more obstacles 150 may be based on the information/data from the one or more image pedestrian detectors 210, the one or more high recall obstacle detectors 215, the one or more patch generators 220, the one or more image patch not-a-pedestrian detectors 225, and/or the one or more image patch vegetation detectors 230.

According to various embodiments, the one or more detectors (e.g., 210, 215, 225, 230, and/or other suitable detector) may function as a collidable detector. The collidable detector may be able to determine a collidability (i.e., the ability to be collided with) of one or more obstacles. For example, according to various embodiments, collidability may indicate whether an obstacle is collidable (i.e., suitable for being collided with and/or approved for collision by the vehicle) and/or not non-collidable (i.e., not non-suitable for being collided with and/or not being capable of being approved for collision by the vehicle). According to various embodiments, when determining whether an obstacle is not non-collidable, the collidable detector may function as a non-collidable detector. According to various embodiments, the collidable detector and non-collidable detector may be a same detector and/or different detectors.

According to various embodiments, the classified/annotated obstacles 150 may be sent downstream to one or more planning modules 245. The one or more planning modules 245 may be configured to plan a trajectory of the vehicle 105, including any changes in direction, velocity, etc. According to various embodiments, the one or more planning modules 245 may incorporate high precision data from the environment of the vehicle 105. The high precision data from the environment of the vehicle 105 may be gathered, calculated, and/or determined via one or more high precision perceived environment modules 250.

According to various embodiments, the detectors (e.g., 210, 215, 225, 230, and/or other suitable detector) may be configured to determine a confidence level for each detection. For example, the collidable detector may be configured to assign a confidence to a label that an obstacle, that was detected, is collidable, and the non-collidable detector may be configured to assign a confidence to a label that the object, that was detected, is not non-collidable. The one or more planning modules 245, then, may the be configured to use a threshold for each of the confidences to determine that the detected object/obstacle is collidable and not non-collidable. If either confidence is below the threshold, then the one or more planning modules 245 may not accept any plans that would collide with the detected object/obstacle. According to various embodiments, if both confidences are above the threshold, then the one or more planning modules may be configured to accept a plan that collides with the detected object/obstacle. According to various embodiments, the threshold may be adjusted. Preferably, the threshold may be at least 90% of a maximum confidence. More preferably, the threshold may be 95% of the maximum confidence. More preferably, the threshold may be 99% of the maximum confidence.

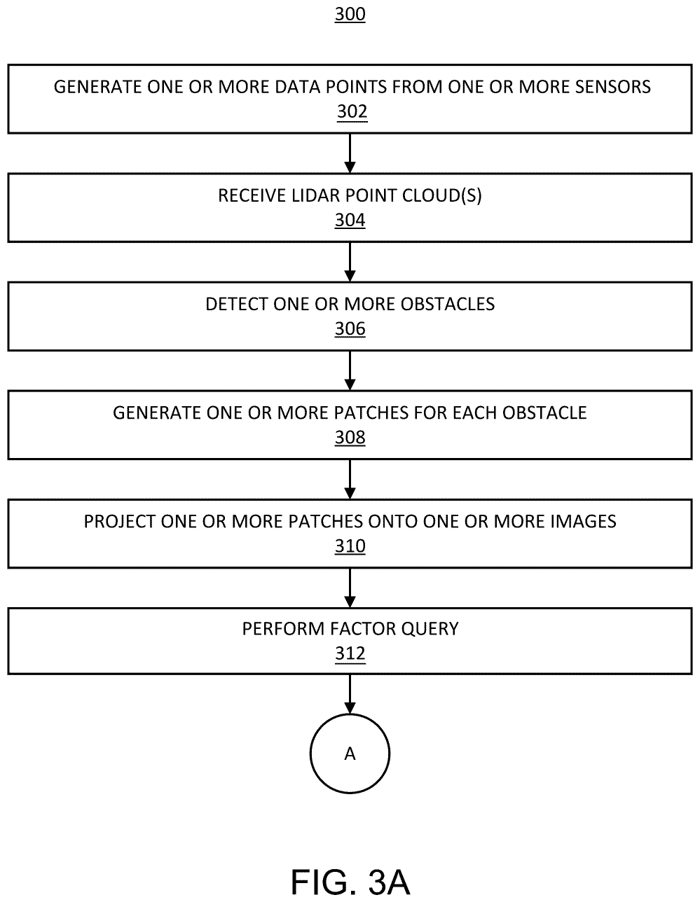

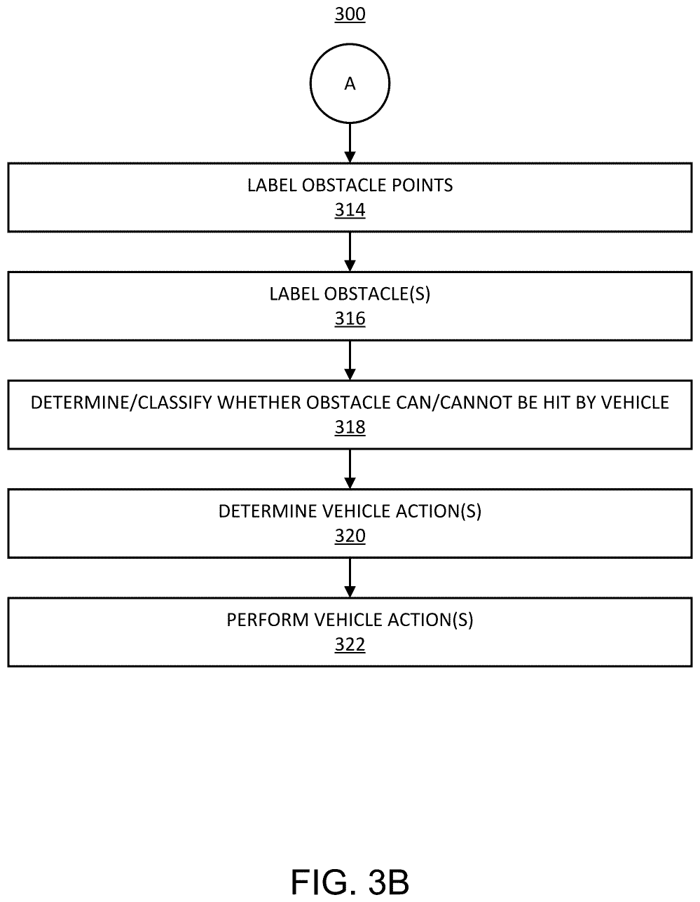

Referring now to FIGS. 3A-3B, an example flowchart of a method 300 for identifying water on a road surface and adjusting a speed of a vehicle accordingly is described, in accordance with various embodiments of the present disclosure.

At 302, one or more data points are collected, generated, and/or produced by one or more sensors, (e.g., one or more LiDAR sensors, one or more radio detection and ranging (RADAR) sensors, and one or more cameras, one or more ultrasonic transducers, and/or other suitable sensors). According to various embodiments, the one or more data points comprise one or more LiDAR point clouds and one or more camera images for a specified capture time.

According to various embodiments, the one or more LiDAR point clouds may be generated using a LiDAR system including one or more LiDAR sensors and at least one computer memory and computer processor. According to various embodiments, the one or more LiDAR point clouds may be representative of all or part of a vehicle's surrounding environment. The LiDAR point cloud may, e.g., be from a combination of different types of LiDAR sensors. For example, scanning LiDAR sensors, spinning LiDAR sensors, flash LiDAR sensors, and/or other suitable types of LiDAR sensor may be combines in the LiDAR point cloud.

At 304, the one or more LiDAR point clouds are received by a high recall obstacle detector which, at 306, detects one or more obstacles within the one or more LiDAR point clouds. Any known or to be known technique for making an obstacle detection based on sensor data and/or captured images may be used in the embodiments disclosed in this document. According to various embodiments, at 308, one or more patches may be generated for each of one or more detected obstacles within the LiDAR point cloud.

At 310, the one or more LiDAR point clouds, with or without the one or more patches, are projected onto the one or more camera images for the specified capture time. The one or more point clouds may take the form of one or more 2-dimensional (2D) boxed or bounding boxes.

According to various embodiments, at 312, for each obstacle patch projected onto the one or more camera images, a factor query may be performed. The factor query may comprise a color query, a shape query, a movement query, and/or one or more other queries for one or more other suitable factors. According to various embodiments, during the factor query, a factor (e.g., a color, shape, movement, etc.) may be queried, for one or more factor features (e.g., one or more color features, one or more shape features, one or more movement features, etc.), for each of one or more points of the one or more images.

At 314, based in whole or in part on results of the factor query, each of the one or more points may be labeled.

At 316, based on the labels of each of the one or more points, a label may be assigned for each obstacle. For example, each obstacle may be labeled as a pedestrian, a vehicle, a piece of vegetation, and/or one or more other suitable type of obstacle. According to various embodiments, assigned a label for an obstacle comprises determining a label for the obstacle. According to various embodiments, the label may indicate the collidability (i.e., the ability to be collided with) of one or more obstacles. For example, according to various embodiments, the label may indicate whether an obstacle is collidable (i.e., suitable for being collided with and/or approved for collision by the vehicle) and/or not non-collidable (i.e., not non-suitable for being collided with and/or not being capable of being approved for collision by the vehicle).

According to various embodiments, determining the label for the obstacle may be performed using a suitable device, system, module, etc., such as, e.g., the image pedestrian detector 210, high recall obstacle detector 215, image patch not-a-pedestrian detector 225, image patch vegetation detector 230, and the annotated high recall obstacle detector 240 of FIG. 2.

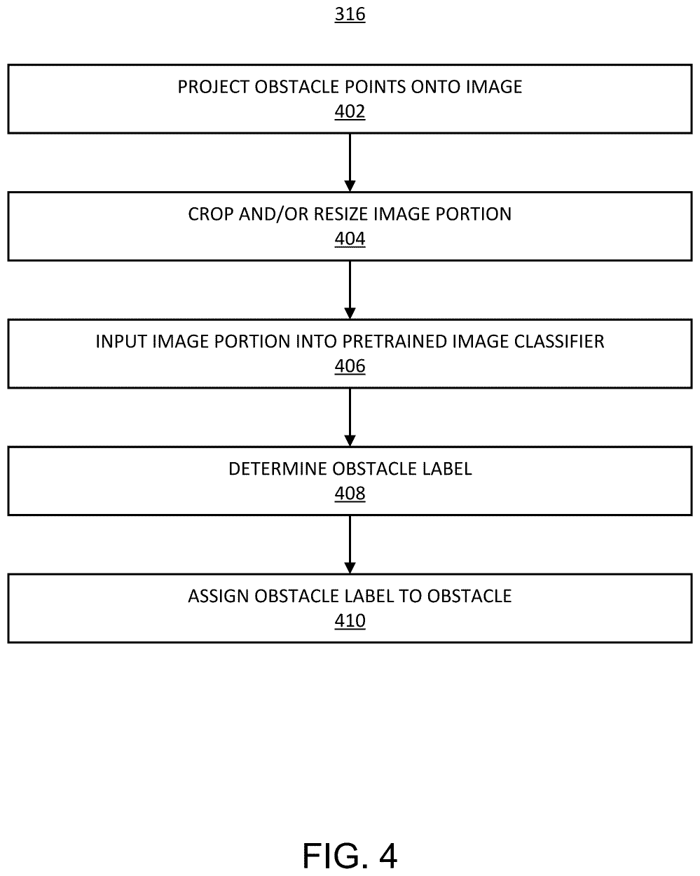

According to various embodiments, the labeling of the obstacles, at 316 of FIG. 3, may be performed using an auto-labeling process, as shown, e.g., in FIG. 4. According to various embodiment, the auto-labeling processor may directly query the label of the obstacle from the image. During auto-labeling, obstacle points, at 402, may be projected onto an image. The obstacle points may take the form of a 2D bounding box. The portion of the image represented by the 2D bounding box may, at 404, be cropped and/or resized and preprocessed. The preprocessed and (optionally) resized portion of the image may, at 406, then be input into a pretrained image classifier. The pretrained image classifier, at 408, may analyze factors of the image portion to determine a label of the obstacle. The factors may comprise color, shape, movement, and/or one or more other suitable factors. For example, the pretrained image classifier may be configured to determine whether an obstacle is a piece of vegetation based on one or more shapes, colors, movement, and/or other factors of the obstacle. The pretrained image classifier may, at 410, assign the determined label to the obstacle.

According to various embodiments, at 318, each obstacle may be analyzed to determine whether the obstacle can or cannot be hit by the vehicle. According to various embodiments, the perception system may be configured to determine whether the obstacle is something that the vehicle can hit, classify the obstacle as something that the vehicle can hit when the it is determined that the obstacle is something that the vehicle can hit, determine whether the obstacle is not something that the vehicle cannot hit, and classify the obstacle as not something that the vehicle cannot hit when the it is determined that the obstacle is not something that the vehicle cannot hit. According to various embodiments, vehicles and pedestrians may be obstacles that the vehicle cannot hit, and pieces of vegetation (or certain types of pieces of vegetation) may be obstacles that the vehicle can hit and not obstacles that the vehicle cannot hit. However, any suitable label for objects which can be hit by the vehicle and/or cannot be hit by the vehicle may be incorporated, while maintaining the spirit and functionality of the present disclosure.

At 320, based on one or more of the labels of the obstacle, the classification of whether the vehicle can hit the obstacle, the classification of whether the vehicle cannot not hit the obstacle, and the classification of whether the vehicle cannot hit the object, the planning module may determine one or more actions for the vehicle to take. The one or more actions may comprise altering a speed of the vehicle (e.g., increase speed, decrease speed, stop, etc.), altering a trajectory of the vehicle (e.g., a direction of the vehicle, a path for the vehicle to take, a final destination of the vehicle, etc.), and/or other suitable actions. At 322, the planning module may cause the vehicle to perform the one or more actions.

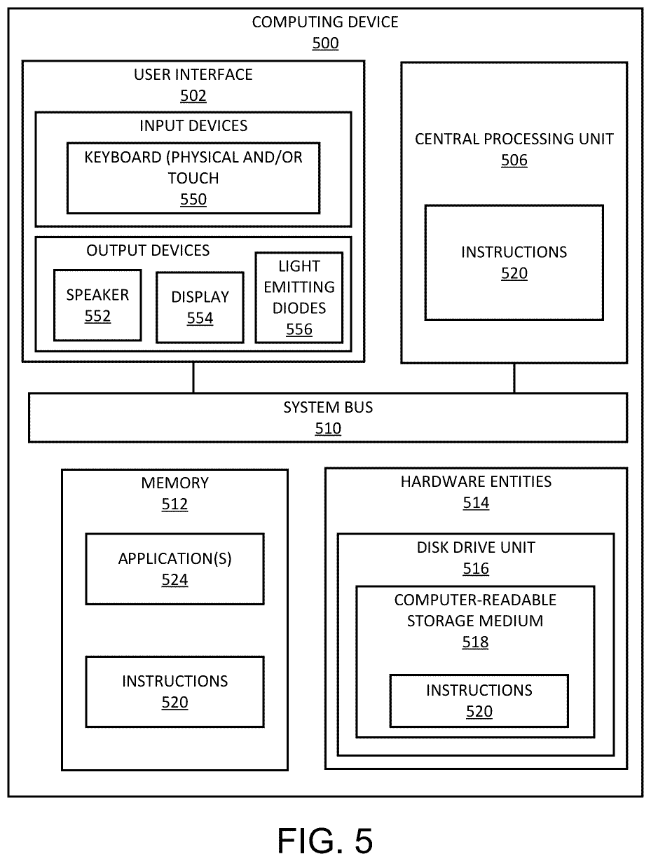

Referring now to FIG. 5, an illustration of an example architecture for a computing device 500 is provided. The computing device 130 of FIG. 1 may be the same as or similar to computing device 500. As such, the discussion of computing device 500 is sufficient for understanding the computing device 130 of FIG. 1, for example.

Computing device 500 may comprise greater or fewer components than those shown in FIG. 1. The hardware architecture of FIG. 5 represents one example implementation of a representative computing device configured to one or more methods and means for detecting and labeling obstacles within a vehicle environment, and determining a course of action for the vehicle, as described herein. As such, the computing device 500 of FIG. 5 implements at least a portion of the method(s) described herein (for example, method 300 of FIGS. 3A-3B and method 316 of FIG. 4).

Some or all components of the computing device 500 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 5, the computing device 500 comprises a user interface 502, a Central Processing Unit (“CPU”) 506, a system bus 510, a memory 512 connected to and accessible by other portions of computing device 500 through system bus 510, and hardware entities 514 connected to system bus 510. The user interface can include input devices and output devices, which facilitate user-software interactions for controlling operations of the computing device 500. The input devices include, but are not limited to, a physical and/or touch keyboard 550. The input devices can be connected to the computing device 500 via a wired or wireless connection (e.g., a Bluetooth® connection). The output devices include, but are not limited to, a speaker 552, a display 554, and/or light emitting diodes 556.

At least some of the hardware entities 514 perform actions involving access to and use of memory 512, which can be a Random Access Memory (RAM), a disk driver and/or a Compact Disc Read Only Memory (CD-ROM), among other suitable memory types. Hardware entities 514 can include a disk drive unit 516 comprising a computer-readable storage medium 518 on which is stored one or more sets of instructions 520 (e.g., programming instructions such as, but not limited to, software code) configured to implement one or more of the methodologies, procedures, or functions described herein. The instructions 520 can also reside, completely or at least partially, within the memory 512 and/or within the CPU 506 during execution thereof by the computing device 500. The memory 512 and the CPU 506 also can constitute machine-readable media. The term “machine-readable media”, as used here, refers to a single medium or multiple media (e.g., a centralized or distributed database, and/or associated caches and servers) that store the one or more sets of instructions 520. The term “machine-readable media”, as used here, also refers to any medium that is capable of storing, encoding or carrying a set of instructions 520 for execution by the computing device 500 and that cause the computing device 500 to perform any one or more of the methodologies of the present disclosure.

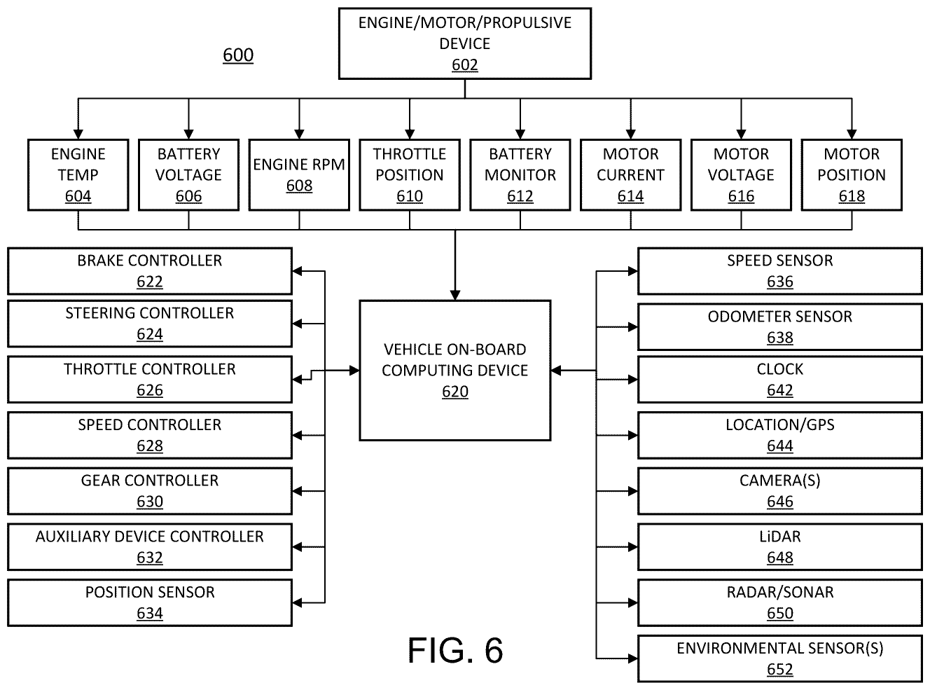

Referring now to FIG. 6, example vehicle system architecture 600 for a vehicle is provided, in accordance with various embodiments of the present disclosure.

Vehicle 105 of FIG. 1 can have the same or similar system architecture as that shown in FIG. 6. Thus, the following discussion of vehicle system architecture 600 is sufficient for understanding vehicle 105 FIG. 1.

As shown in FIG. 6, the vehicle system architecture 600 includes an engine, motor or propulsive device (e.g., a thruster) 602 and various sensors 604-618 for measuring various parameters of the vehicle system architecture 600. In gas-powered or hybrid vehicles having a fuel-powered engine, the sensors 604-618 may include, for example, an engine temperature sensor 604, a battery voltage sensor 606, an engine Rotations Per Minute (RPM) sensor 608, and/or a throttle position sensor 610. If the vehicle is an electric or hybrid vehicle, then the vehicle may have an electric motor, and accordingly will have sensors such as a battery monitoring system 612 (to measure current, voltage and/or temperature of the battery), motor current 614 and voltage 616 sensors, and motor position sensors such as resolvers and encoders 618.

Operational parameter sensors that are common to both types of vehicles include, for example: a position sensor 634 such as an accelerometer, gyroscope and/or inertial measurement unit; a speed sensor 636, and/or an odometer sensor 638. The vehicle system architecture 600 also may have a clock 642 that the system uses to determine vehicle time during operation. The clock 642 may be encoded into the vehicle on-board computing device 620, it may be a separate device, or multiple clocks may be available.

The vehicle system architecture 600 also may comprise various sensors that operate to gather information about the environment in which the vehicle is traveling. These sensors may include, for example: a location sensor 644 (for example, a Global Positioning System (GPS) device); object detection sensors such as one or more cameras 646, a LIDAR sensor system 648; and/or a radar and/or a sonar system 650. The sensors also may comprise environmental sensors 652 such as a precipitation sensor and/or ambient temperature sensor. The object detection sensors may enable the vehicle system architecture 600 to detect objects that are within a given distance range of the vehicle 600 in any direction, while the environmental sensors 652 collect data about environmental conditions within the vehicle's area of travel.

During operations, information is communicated from the sensors to an on-board computing device 620. The on-board computing device 620 may be configured to analyze the data captured by the sensors and/or data received from data providers, and may be configured to optionally control operations of the vehicle system architecture 600 based on results of the analysis. For example, the on-board computing device 620 may be configured to control: braking via a brake controller 622; direction via a steering controller 624; speed and acceleration via a throttle controller 626 (in a gas-powered vehicle) or a motor speed controller 628 (such as a current level controller in an electric vehicle); a differential gear controller 630 (in vehicles with transmissions); and/or other controllers.

Geographic location information may be communicated from the location sensor 644 to the on-board computing device 620, which may then access a map of the environment that corresponds to the location information to determine known fixed features of the environment such as streets, buildings, stop signs and/or stop/go signals. Captured images from the cameras 646 and/or object detection information captured from sensors such as LIDAR 648 is communicated from those sensors to the on-board computing device 620. The object detection information and/or captured images are processed by the on-board computing device 620 to detect objects in proximity to the vehicle. Any known or to be known technique for making an object detection based on sensor data and/or captured images may be used in the embodiments disclosed in this document.

The features and functions described above, as well as alternatives, may be combined into many other different systems or applications. Various alternatives, modifications, variations or improvements may be made by those skilled in the art, each of which is also intended to be encompassed by the disclosed embodiments.

What is claimed is:

1. A method for detecting and labeling a collidability of obstacles within a vehicle environment, comprising:
generating one or more data points from one or more sensors coupled to a vehicle, wherein:
the one or more sensors comprise:
a Light Detection and Ranging (LiDAR) sensor; and
a camera, and
the one or more data points comprise:
a LiDAR point cloud generated by the LiDAR sensor; and
an image captured by the camera; and
using a processor:
detecting one or more obstacles within the LiDAR point cloud;
performing a factor query on the image for each of the one or more detected obstacles;
for each of the one or more detected obstacles, based on the factor query, determining a label for the obstacle,
wherein the label indicates whether each of the one or more detected obstacles is:
collidable; and
not non-collidable; and
for each of the one or more detected obstacles, labeling the obstacle with the label.

2. The method of claim 1, wherein the performing the factor query comprises one or more of:
performing a color query on the image for each of the one or more detected obstacles;
performing a shape query on the image for each of the one or more detected obstacles; and
performing a movement query on the image for each of the one or more detected obstacles.

3. The method of claim 1, further comprising:
using the processor:
for each of the one or more detected obstacles, based on the label of the obstacle, determining one or more vehicle actions for the vehicle to perform; and
causing the vehicle to perform the one or more actions.

4. The method of claim 3, wherein the one or more actions comprises one or more of:
increasing a speed of the vehicle;
decreasing a speed of the vehicle;
stopping the vehicle; and
adjusting a trajectory of the vehicle.

5. The method of claim 1, further comprising:
generating a patch for each of the one or more detected obstacles;
projecting the LiDAR point cloud into the image, wherein:
each patch represents a region of the image for each of the one or more detected obstacles, and
each patch forms a bounding box on the image; and
cropping the region of the image within the bounding box, forming a cropped image.

6. The method of claim 5, further comprising resizing the cropped image, forming a resized image,
wherein performing the factor query comprises performing the factor query on the resized image.

7. The method of claim 1, further comprising:
for each of the one or more detected obstacles, based on the factor query, determining whether the obstacle is one or more of:
a piece of vegetation;
a pedestrian; and
a vehicle.

8. A system for detecting and labeling a collidability of obstacles within a vehicle environment, comprising:
a vehicle;
one or more sensors, coupled to the vehicle, configured to generate one or more data points, wherein:
the one or more sensors comprise:
a Light Detection and Ranging (LiDAR) sensor; and
a camera, and
the one or more data points comprise:
a LiDAR point cloud generated by the LiDAR sensor; and
an image captured by the camera; and
a processor configured to:
detect one or more obstacles within the LiDAR point cloud;
perform a factor query on the image for each of the one or more detected obstacles;
for each of the one or more detected obstacles, based on the factor query, determine a label for the obstacle,
wherein the label indicates whether each of the one or more detected obstacles is:
collidable; and
not non-collidable; and
for each of the one or more detected obstacles, label the obstacle with the label.

9. The system of claim 8, wherein the performing the factor query comprises one or more of:
performing a color query on the image for each of the one or more detected obstacles;
performing a shape query on the image for each of the one or more detected obstacles; and
performing a movement query on the image for each of the one or more detected obstacles.

10. The system of claim 8, wherein the processor is further configured to:
for each of the one or more detected obstacles, based on the label of the obstacle, determine one or more vehicle actions for the vehicle to perform; and
cause the vehicle to perform the one or more actions.

11. The system of claim 10, wherein the one or more actions comprises one or more of:
increasing a speed of the vehicle;
decreasing a speed of the vehicle;
stopping the vehicle; and
adjusting a trajectory of the vehicle.

12. The system of claim 8, wherein the processor is further configured to:
generate a patch for each of the one or more detected obstacles;
project the LiDAR point cloud into the image,
wherein:
each patch represents a region of the image for each of the one or more detected obstacles, and
each patch forms a bounding box on the image; and
crop the region of the image within the bounding box, forming a cropped image.

13. The system of claim 12, wherein:
the processor is further configured to resize the cropped image, forming a resized image, and
the performing the factor query comprises performing the factor query on the resized image.

14. The system of claim 8, wherein the processor is further configured to:
for each of the one or more detected obstacles, based on the factor query, determine whether the obstacle is one or more of:
a piece of vegetation;
a pedestrian; and
a vehicle.

15. A system for detecting and labeling a collidability of obstacles within a vehicle environment, comprising:
a vehicle;
one or more sensors, coupled to the vehicle, configured to generate one or more data points, wherein:
the one or more sensors comprise:
a Light Detection and Ranging (LiDAR) sensor; and
a camera, and
the one or more data points comprise:
a LiDAR point cloud generated by the LiDAR sensor; and
an image captured by the camera; and
a computing device, comprising a processor and a memory, coupled to the vehicle, configured to store programming instructions that, when executed by the processor, cause the processor to:
detect one or more obstacles within the LiDAR point cloud;
perform a factor query on the image for each of the one or more detected obstacles;
for each of the one or more detected obstacles, based on the factor query, determine a label for the obstacle,
wherein the label indicates whether each of the one or more detected obstacles is:
collidable; and
not non-collidable; and
for each of the one or more detected obstacles, label the obstacle with the label.

16. The system of claim 15, wherein the performing the factor query comprises one or more of:
performing a color query on the image for each of the one or more detected obstacles;
performing a shape query on the image for each of the one or more detected obstacles; and
performing a movement query on the image for each of the one or more detected obstacles.

17. The system of claim 15, wherein the programming instructions are further configured, when executed by the processor, to cause the processor to:
for each of the one or more detected obstacles, based on the label of the obstacle, determine one or more vehicle actions for the vehicle to perform; and
cause the vehicle to perform the one or more actions.

18. The system of claim 17, wherein the one or more actions comprises one or more of:
increasing a speed of the vehicle;
decreasing a speed of the vehicle;
stopping the vehicle; and
adjusting a trajectory of the vehicle.

19. The system of claim 15, wherein:
the programming instructions are further configured, when executed by the processor, to cause the processor to:
generate a patch for each of the one or more detected obstacles;
project the LiDAR point cloud into the image,
wherein:
each patch represents a region of the image for each of the one or more detected obstacles, and
each patch forms a bounding box on the image;
crop the region of the image within the bounding box, forming a cropped image; and
resize the cropped image, forming a resized image, and
the performing the factor query comprises performing the factor query on the resized image.

20. The system of claim 15, wherein the programming instructions are further configured, when executed by the processor, to cause the processor to:
for each of the one or more detected obstacles, based on the factor query, determine whether the obstacle is one or more of:
a piece of vegetation;
a pedestrian; and
a vehicle.
